(19) United States
(12) Patent Application Publication
(10) Pub. No.: US 2017/0219399 A1
(43) Pub. Date: Aug. 3, 2017

(54) MAGNETO-INDUCTIVE FLOW MEASURING DEVICE WITH A PLURALITY OF MEASURING ELECTRODE PAIRS AND DIFFERENT MEASURING TUBE CROSS-SECTIONS

(71) Applicant: Endress + Hauser Flowtec AG, Reinach (CH)

(72) Inventors: Thomas Kung, Basel (CH); Gunther Bahr, Therwil (CH); Frank Voigt, Weil am Rhein (DE)

(21) Appl. No.: 15/500,694

(22) PCT Filed: Jul. 31, 2015
(86) PCT No.: PCT/EP2015/067638

§ 371 Date: Jan. 31, 2017

(30) Foreign Application Priority Data
Aug. 4, 2014 (DE) 102014111047.1

(51) Int. Cl. G01F 1/58

(52) U.S. Cl. CPC G01F 1/584

(57) ABSTRACT

An apparatus for measuring flow of a fluid flowing using the magneto-inductive measuring principle, comprising a measuring tube having at least two subsections, wherein the subsections differ in diameter and/or geometry of cross sectional area; at least one magnet system having at least two coils for producing a magnetic field directed essentially perpendicularly to the flow direction of the fluid; at least two measuring electrode pairs for sensing induced voltage, wherein at least one measuring electrode pair is arranged in a first subsection and a second measuring electrode pair in a second subsection, wherein each measuring electrode pair includes first and second measuring electrodes, which lie opposite one another in the measuring tube and the respective connecting lines of the measuring electrodes are perpendicular to the tube axis and perpendicular to the magnetic field, and an electronics unit for signal registration and/or evaluation and for power supply of the coils, wherein the electronics unit is so embodied that it determines from the induced voltage the flow velocity of the fluid and/or the flow rate of the fluid for at least one subsection.

The invention relates to an apparatus and to a method for measuring flow of a fluid flowing through a measuring tube using the magneto-inductive measuring principle.

Magneto-inductive flow measuring devices are widely applied in process and automation technology in the case of fluids having an electrical conductivity of, for instance, 5 μS/cm. Corresponding flow measuring devices are sold, for example, by the applicant, for example, under the mark PROMAG, in the most varied forms of embodiment for various fields of application.

The magneto-inductive measuring principle rests on Faraday's law of magnetic induction and is known from multiple publications. By means of a magnet system secured on a measuring tube subsection, a magnetic field of constant strength as a function of time is produced directed essentially perpendicularly to the flow direction of the conductive fluid. In this way, ions present in the flowing fluid are turned in opposed directions as a function of their charges. The electrical voltage resulting from this charge separation is sensed by means of at least one measuring electrode pair likewise secured in the measuring tube subsection. The sensed voltage is proportional to the flow velocity of the fluid and therewith proportional to the volume flow rate.

The accuracy of measurement of a magneto-inductive flow measuring device depends, in such case, on many different factors. Some thereof concern the construction per se, such as, for example, the positioning accuracy of the magnet system, or the read out of the measurement signal via the at least one measuring electrode pair as well as the geometry of the electrode pair; others are predetermined by the particular flow velocity of the fluid as well as by the physical properties of the fluid.

The measuring electrodes should, in principle, provide a sensitive and simultaneously low-disturbance registering of the measurement signal. Usually, a measuring electrode is composed of two parts: An electrode shaft, which resides at least almost completely in the wall of the measuring tube, and an electrode head for direct coupling with the fluid and for registering the measurement signal. The geometry of the electrode head can be, for example, pointed or have the shape of a mushroom cap.

As regards the arrangement of the at least one measuring electrode pair in the measuring tube subsection, the measuring electrodes should lie opposite one another in the measuring tube and the connecting line of the electrodes should be perpendicular to the tube axis and perpendicular to the magnetic field.

Besides these rather structural aspects, the electrical conductivity of the fluid, the flow profile reigning in the measuring tube as well as the flow velocity of the fluid play a large role in the accuracy of measurement.

Known from the state of the art is to use more than one measuring electrode pair, this being disclosed, for example, in DE 10 2006 014 679 A1. The reasons for such an approach vary from case to case. The goal, however, in all situations is to improve the accuracy of measurement. In the previously unpublished application No. 102013103211.7 filed on 28 Mar. 2013, a magneto-inductive flow measuring device with a plurality of measuring electrode pairs is described, in the case of which a redundant sensing of the induced voltage occurs. In this way, the signal to noise ratio—the ratio of the wanted signal fraction to the disturbance signal fraction in the measurement signal—is optimized. In other words, the measured value scatter and measurement deviation are reduced.

Another approach for increasing the accuracy of measurement is to modify the measuring tube towards such goal. In EP2600119A1, for example, a subdividing of the measuring tube into an inflow section, a measuring section and an outflow section is disclosed, wherein the three measuring tube sections have different cross sections. Especially, a cross section smaller than the other two sections is selected for the measuring section. Especially, the cross section of the measuring section has a rectangular measuring tube profile. The cross section lessening offers the advantage that the flow velocity of the fluid in the region of the measuring section is increased.

Small flow velocities lead to a measurement signal that is very small. Moreover, zero point instabilities can influence the measuring more strongly negatively in the case of smaller flow velocities. A greater flow velocity leads to a stronger measurement signal due to the greater charge separation caused by the magnetic field and correspondingly also increases the accuracy of measurement.

On the other hand, very high flow velocities lead to the occurrence of cavitation, which likewise influences the accuracy of measurement negatively, so that, in regard to the accuracy of measurement, it is advantageous to measure neither at very high nor at very small flow velocities.

The following should also be mentioned with reference to conductivity. For fluids with low electrical conductivity, the disturbing noise at the measuring electrodes rises with increasing flow velocity significantly more strongly than the wanted signal. Therefore, it is advantageous to avoid high flow velocities in the case of fluids with low electrical conductivities. For the example of water, this holds, for example, for conductivities of ≦20 μS/cm.

Another important aspect concerns the flow profile reigning in the measuring tube. This depends on the Reynolds number, which, in turn, depends on the flow velocity, the geometry of the measuring tube and its surface roughness in the interior, on the physical and/or chemical parameters of the medium, such as, for example, the viscosity, and on the inflow conditions of the fluid flowing in the measuring tube before the measuring tube subsection, in which the measuring device is mounted. In the case of given flow quantity, respectively in the case of given volume flow, the cross section of the measuring tube determines the flow velocity of the fluid. For very low flow velocities, in the case of a sufficiently long, straight, inflow section of the measuring tube adjoining the measuring tube subsection, a laminar flow profile is typically present. If the flow velocity, respectively the Reynolds number, increases, a transitional region is reached, in which the flow is susceptible to the smallest disturbances, until after a certain flow velocity an increasingly turbulent flow profile is present.

In the case of measurements, for which the Reynolds number lies in the transitional region between typically laminar and turbulent flow, high measurement deviations and measured values scatterings occur. Therefore, in this case, the possible measurement deviations are greater than in the case of a laminar or turbulent flow profile. It is thus, moreover, advantageous in measuring the flow to avoid this transitional region between laminar and turbulent flow.

In summary, the flow velocity, which depends on the cross section of the measuring tube, determines decisively the accuracy of measurement of the magneto-inductive flow measurement.

An object of the present invention is, thus, to provide an apparatus and a method for measuring flow according to the magneto-inductive measuring principle, wherein the flow velocity of the fluid, based on which the flow rate is determined, lies, for each application, to the extent possible, in an optimal range for the flow velocity.

This object is achieved according to the invention by an apparatus for measuring flow of a fluid flowing through a measuring tube using the magneto-inductive measuring principle, comprising

(I) a measuring tube having at least two subsections following one after the other in the flow direction of the fluid, wherein the subsections differ in diameter and/or geometry of cross sectional area, p (II) at least one magnet system having at least two coils for producing a magnetic field directed essentially perpendicularly to the flow direction of the fluid,

(III) at least two measuring electrode pairs for sensing induced voltage, wherein at least one measuring electrode pair is arranged in a first subsection and a second measuring electrode pair in a second subsection, wherein each measuring electrode pair includes first and second measuring electrodes, wherein the measuring electrodes lie opposite one another in the measuring tube and the respective connecting lines of the measuring electrodes are perpendicular to the tube axis and perpendicular to the magnetic field, and

(IV) an electronics unit for signal registration and/or evaluation and power supply of the coils, wherein the electronics unit is so embodied that it determines from the induced voltage the flow velocity and/or the flow rate of the fluid for at least one subsection.

In the case of a particular flow rate, thus, the flow velocities in the at least two subsections of the measuring tube are different. Then, by means of various manners of proceeding described below, that subsection can be selected, for which the flow velocity lies in the optimal range for flow velocity.

It is advantageous, when there is associated with the electronics unit a memory unit, in which experimentally ascertained or mathematical model calculated, fluid-specific and/or measuring tube specific parameters and/or characteristic curves are stored, and the electronics unit is so embodied that it determines from flow velocity of the fluid and subsection cross section, according to an applied mathematical model and based on the parameters and/or characteristic curves, the flow profile reigning in each subsection.

In a preferred embodiment, the electronics unit is, furthermore, so embodied that it, to the extent possible, selects for determining the flow the subsection, in which the reigning flow profile lies outside a transitional region between laminar and turbulent flow.

In an additional embodiment, the electronics unit is so embodied that for determining the flow it provides the flow velocities for the different subsections with weighting factors suitable for the respective flow profiles and then averages therewith over the flow velocities in the different subsections. This procedure enables comparing the two values for the flow determined for different flow velocities, and eliminating inaccuracies due to respectively too high or too low flow velocities.

In reference to the influence of the electrical conductivity of the fluid already described above, it is advantageous to provide a sensor element for registering the electrical conductivity of the fluid. The electronics unit should then be so embodied that for fluids with a composition, in the case of which the signal noise in the flow range relevant for the measuring increases with increasing flow velocity more strongly than the measurement signal, especially in the case of fluids with a small electrical conductivity, there is used, for measuring flow, that measuring electrode pair, which is arranged in the subsection with the greatest cross section.

It is, furthermore, advantageous, when the measuring electrodes have different geometries, especially a pointed, pin-shaped, cylindrical, conical or mushroom cap geometry. The different geometries influence the flowing fluid in different ways, since they protrude differently into the respective measuring tube subsections with which they are associated. Correspondingly, the reigning flow profile is differently influenced, depending on the selected geometry of the measuring electrode. Furthermore, the choice of a pointed geometry in the subsection with the greater diameter prevents formation of deposits in the case of susceptible media due to the lower flow velocities reigning in this subsection.

In a preferred embodiment, at least two measuring electrode pairs are installed in at least one subsection. Besides the measuring at subsections with different cross sections, this embodiment permits a redundant and therewith more exact sensing of the measurement signal.

In an additional preferred embodiment, the magnet system is so constructed that it extends over all subsections. Alternatively, a separate magnet system can be provided for each subsection.

The object of the invention is achieved, furthermore, by a method for measuring a fluid flowing through a measuring tube using the magneto-inductive measuring principle with

(I) a measuring tube, which is composed of at least two subsections following one after the other in the flow direction of the fluid, wherein the subsections differ in diameter and/or geometry of cross sectional area,

(II) wherein a magnetic field is produced directed essentially perpendicularly to the flow direction of the fluid and passing through the measuring tube,

(III) wherein the voltage induced in each subsection is sensed, and

(IV) wherein, for at least one subsection, the flow velocity and/or the flow rate of the fluid is determined from the induced voltage.

In such case, it is advantageous, when, based on experimentally ascertained or mathematical model calculated, fluid-specific and/or measuring tube specific parameters and/or characteristic curves stored in a memory unit, the flow profile reigning according to an applied mathematical model is determined for each subsection from the flow velocity of the fluid and the cross section of the subsection.

Likewise it is advantageous, when, for determining the flow, to the extent possible, on the one hand, that subsection is selected, in which the reigning flow profile lies outside a transitional regidn between laminar and turbulent flow and, on the other hand, no extremely small or large flow velocity occurs.

In a preferred embodiment for determining the flow, the flow velocities for the different subsections are provided weighting factors suitable for the flow profiles. Then, an averaging is made therewith over the flow velocities of the different subsections.

In an especially preferred embodiment, in the case of small flow rates, that measuring electrode pair is used, which is arranged in the subsection with the smallest cross section. That is the subsection with the highest flow velocity. Correspondingly, the accuracy of measurement is increased. In the case of water, for example, this pertains to flow velocities of ≦10 cm/s in the subsections with greater diameters.

In similar manner, it is advantageous to use, in the case of high flow rates, that measuring electrode pair, which is arranged in the subsection with the greatest cross section. There, the flow velocity is the smallest, so that the occurrence of cavitation can be avoided, such as can occur in the case of water at flow velocities ≧12 m/s. In the case of these flow velocities in the subsections with smaller diameter, the subsection with greater diameter can be used. In order that the gas bubbles possibly arising in the case of cavitation not lead to disturbances in the subsection with greater diameter, the arrangement of the subsections in the measuring tube with reference to the flow direction is preferably from subsections with greater diameter to subsections with smaller diameter.

The invention will now be described based on the appended drawing, the figures of which show as follows:

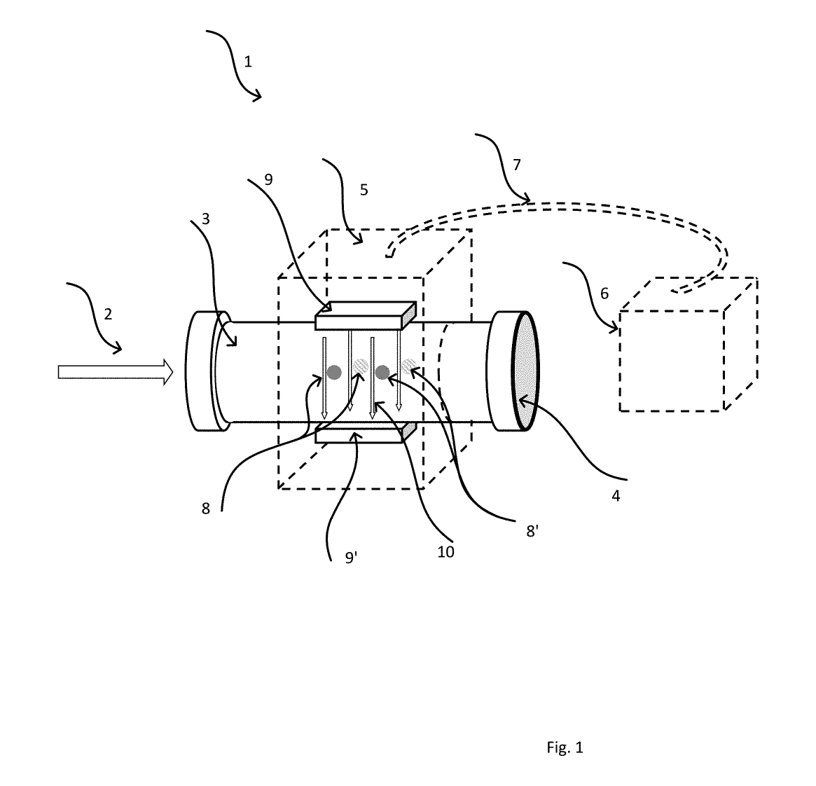

FIG. 1 a magneto-inductive flow measuring device according to the state of the art;

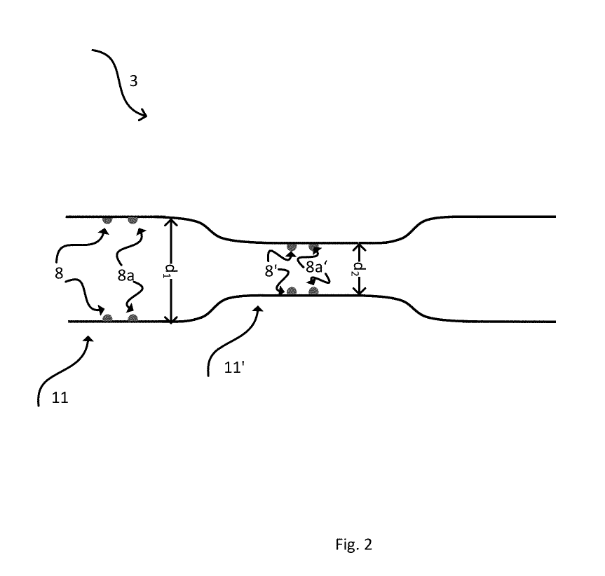

FIG. 2 a measuring tube of the invention having two subsections with different cross sections;

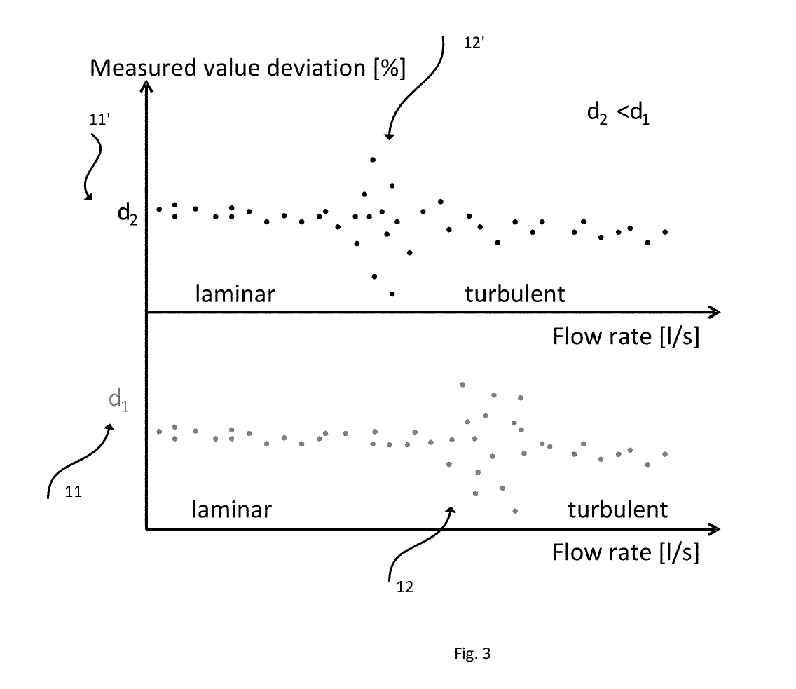

FIG. 3 a schematic graph illustrating the dependence of the measured value deviation on the reigning flow profile; and

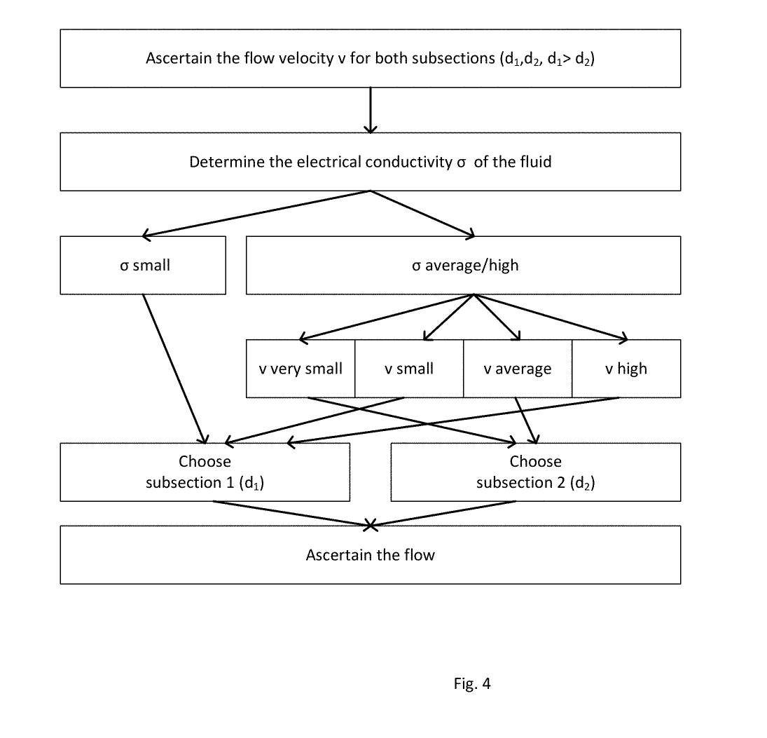

FIG. 4 a block diagram of a method of the invention for ascertaining flow in the arrangement of FIG. 2.

FIG. 1 shows a magneto-inductive flow measuring device 1 for measuring flow of a fluid 2 flowing through a measuring tube 3. The measuring tube is provided with an electrically insulating liner 4 in the fluid facing region, i.e. on the inside, over the entire length. Shown are two measuring electrode pairs 8,8′ for sensing induced voltage and a magnet system 9, 9′, which is schematically illustrated as two boxes. The magnet system includes at least two coils for producing the magnetic field 10 and in an optional embodiment of the invention also pole shoes for implementing an advantageous spatial distribution of the magnetic field. The respective connecting axes of the measuring electrode pairs 8, 8′ are each perpendicular to the connecting axis of the field coils 9, 9′ positioned on oppositely lying sides of the measuring tube.

The sensor unit with its respective components, such as e.g. the measuring electrode pairs 8, 8′ and the magnet system 9, 9′, is usually at least partially surrounded by a housing 5. Further provided, in the housing 5 or, in the present case, outside of the housing 5, is an electronics unit 6 which is electrically connected with the field device via a connecting cable 7. The electronics unit serves for signal registration and/or evaluation and for supplying electrical power to the coils, as well as providing an interface to the environment, e.g. for measured value output or adjustment of the device.

FIG. 2 shows, by way of example, a measuring tube 3 of the invention having two subsections, a first subsection 11 with a large cross section d₁ and a second subsection 11′ with a small cross section d₂. A preferred combination would be a nominal diameter of DN15 for the first subsection 11 and DN8 for the second subsection 11′. Located in the first subsection 11 is a first measuring electrode pair 8, and in the second subsection 11′ a second measuring electrode pair 8′. Of course, this is only an example of an embodiment. Other size combinations can be selected for the different subsections 11,11′. More than two subsections 11,11′ can be used, or at least one further measuring electrode pair 8a,8a′ can be mounted per subsection 11,11′.

FIG. 3 shows, by way of example, a schematic graph with two subplots for dependence of measured value deviation on the reigning flow profile, respectively flow rate, for a Newtonian liquid for the two subsections 11,11′ with the two cross sections d₁ and d₂, wherein d₁>d₂, such as shown in FIG. 2. For low local flow velocities v, a laminar flow profile is present and for high flow velocities a turbulent flow profile. Between these two flow profiles, there is, in each case, a transitional region 12,12′. Since in the case of given flow rate, the flow velocities and especially Reynolds numbers in the two subsections 11,11′ are not equal, the transitional region 12,12′ for the two subsections 11,11′ lies at different flow rates. The flow velocity in the first subsection 11 with the greater cross section d₁is in the ratio d₂²/d₁² slower than that in the second subsection 11′ with the smaller cross section d₂.

Correspondingly, turbulence begins in the first subsection 11 at higher flow rates, since, in comparison to subsection 11′, the critical Reynolds number is exceeded at higher flow rates. As consequence, the transitional region 12 for the first subsection 11 lies at higher flow rates than the transitional region 12′ for the second subsection 11′. The considerations here rely for simplicity primarily on the flow velocity. Actually, decisive for the flow profile is the product of flow velocity and diameter. Since, however, the flow velocity in the case of given flow rate is, such as above explained, inversely proportional to the square of the diameter, the two variables are not independent of one another and especially the change of velocity predominates over the change of diameter relative to the effect on the Reynolds number.

FIG. 4 shows a block diagram of a method of the invention. Again, the starting point is the arrangement shown in FIG. 2 with two subsections 11,11′ and two measuring electrode pairs 8, 8′. For the example shown here, it is assumed that the transition regions 12,12′ shown in FIG. 3 for the two subsections 11,11′ do not overlap and, thus, lie in different intervals of the flow rate. Therewith, the above described weighting of the individual measured values for determining the flow velocity is absent. Such a method step would, however, be taken into consideration under other circumstances. For purposes of simplification, furthermore, the ascertaining of the reigning flow profile is not shown in this example.

According to the invention, the flow velocity for the two subsections 11,11′ is determined in a first step. Based on experimentally ascertained or mathematical model calculated, fluid-specific parameters and/or characteristic curves furnished in the memory unit, then, in turn, the reigning flow profile can be deduced from the flow velocity. In a second step in the present example, the conductivity of the fluid is determined. According to the invention, this procedure is not absolutely necessary, but in certain circumstances it increases the accuracy of measurement, especially in the case of fluids with low electrical conductivity. If the conductivity is low, the first subsection 11 with the greater cross section d₁ is selected, since, in this case, with increasing flow velocity the velocity dependent, signal noise increases more strongly than the measurement signal.

For average and high electrical conductivities, only the reigning flow profile determines the choice of the subsection 11, 11′. If the given flow rate is such that in the first subsection 11 (d₁>d₂) only a low flow velocity reigns, the second subsection 12a with the smaller diameter d₂ is selected. In this case, the flow velocity is greatest there, but still in the laminar region. Correspondingly, the accuracy of measurement is increased. For low but somewhat higher flow rates, the transitional region 12a begins in the second subsection 11′ (d₂), so that the first subsection 11 with the greater cross section d₁ is selected, where the flow profile is still laminar.

For average flow rates, the situation reverses. In the first subsection 11 (d₁) the transitional region 12 is beginning, while in the second subsection 11a with the smaller cross section d₂ a turbulent flow is already present. Correspondingly, the second subsection 11′ is selected, since, in this case, the flow profile lies outside of the transitional region 12, 12′.

For very high flow velocities, the flow profile is turbulent in both subsections 11, 11′. However, cavitation starts in the second subsection 11′ with the smaller cross section d₂ sooner, so that the first subsection 11 (d₁) is selected.

The block diagram of FIG. 4 can be expanded as much as desired, when, for example, more than two subsections 11, 11′ are used, when more than one measuring electrode pair 8, 81s provided in at least one of the subsections 12, 12′, or when the transition regions 12, 12′ in the different subsections 11, 11′ do not lie in different intervals of the flow velocity, and, correspondingly, an averaging must be performed.

### REFERENCE CHARACTERS

1 magneto-inductive flow measuring device of the state of the art
2 flowing fluid
3 measuring tube
4 electrically insulating lining, liner
5 housing unit or housing
6 electronics unit
7 connecting cable
8, 8′ measuring electrode pairs in the subsections 12, 12′
8a, 8a′ other measuring electrode pairs in the subsections 12, 12′
9, 9′ magnet system having at least two coils and, depending on embodiment, also pole shoes, especially in the case of a one-piece embodiment or in one subsection in the case of a multi-part embodiment
9a,9a′ further magnet system in the case of a multi-part embodiment magnetic field directed perpendicularly to the flow direction of the fluid and to the respective connecting axes of the measuring electrode pairs
11,11′ first subsection (d₁), second subsection (d₂)
12,12′ first transitional region, second transitional region

1-16. (canceled)

17. An apparatus for measuring flow of a fluid using the magneto-inductive measuring principle, comprising:
a measuring tube having at least two subsections following one after the other in the flow direction of the fluid, wherein said subsections differ in diameter and/or geometry of cross sectional area;
at least one magnetic system having at least two coils for producing a magnetic field directed essentially perpendicularly to the flow direction of the fluid;
at least two measuring electrode pairs for sensing induced voltage; and
an electronics unit for signal registration and/or evaluation and power supply of said coils, wherein:
at least one measuring electrode pair of said at least two measuring electrode pairs is arranged in a first subsection of said at least two subsections and a second measuring electrode pair of said at least two measuring electrode pairs in a second subsection of said at least two subsections;
each measuring electrode pair of said at least two measuring electrode pairs includes a first and a second measuring electrode, said measuring electrodes lie opposite one another in or on said measuring tube and the respective connecting lines of said measuring electrodes are perpendicular to said tube axis and perpendicular to the magnetic field and wherein said electronics unit is so embodied that it determines from said induced voltage the flow velocity and/or the flow rate of the fluid for at least one subsection of said at least two subsections.

18. The apparatus as claimed in claim 17, wherein:
there is associated with said electronics unit a memory unit, in which experimentally ascertained or mathematical model calculated, fluid-specific and/or measuring tube specific parameters and/or characteristic curves are stored; and
said electronics unit is so embodied that it determines, for each subsection from the flow velocity of the fluid, the flow profile reigning according to an applied mathematical model based on the parameters and/or characteristic curves.

19. The apparatus as claimed in claim 17, wherein:
said electronics unit is so embodied that, to the extent possible, it selects for determining the flow said subsection, in which the reigning flow profile lies outside a transitional region between laminar and turbulent flow.

20. The apparatus as claimed in claim 17, wherein:
said electronics unit is so embodied that for determining the flow it provides the flow velocities for the different subsections with weighting factors suitable for the respective flow profiles and then averages therewith over the flow velocities in the different subsections.

21. The apparatus as claimed in claim 17, further comprising:
a sensor element for registering the electrical conductivity of the fluid, wherein:
said electronics unit is so embodied that for fluids with a composition, in the case of which the signal noise in the flow range relevant for measuring increases with increasing flow velocity more strongly than the measurement signal, especially in the case of fluids with a small electrical conductivity, there is used, for determining the flow, that measuring electrode pair, which is arranged in the subsection with the greatest cross section.

22. The apparatus as claimed in claim 17, wherein:
the individual measuring electrodes have different geometries, especially a pointed, pin-shaped, cylindrical, conical or mushroom cap geometry.

23. The apparatus as claimed in claim 17, wherein:
at least two measuring electrode pairs are installed in at least one subsection.

24. The apparatus as claimed in claim 17, wherein:
said magnet system is so constructed that it extends over all of said subsections.

25. The apparatus as claimed in claim 17, wherein:
a separate magnet system is provided for each subsection.

26. A method for measuring a flowing fluid using the magneto-inductive measuring principle with a measuring tube, which is composed of at least two subsections following one after the other in the flow direction of the fluid, wherein the subsections differ in diameter and/or geometry of cross sectional area, comprising the steps of:
producing a magnetic field and directed essentially perpendicularly to the flow direction of the fluid passing through the measuring tube;
sensing the voltage induced in each subsection; and
determining for at least one subsection, the flow velocity and/or the flow rate of the fluid from the induced voltage.

27. The method as claimed in claim 26, wherein:
based on experimentally ascertained or mathematical model calculated, fluid-specific and/or measuring tube specific parameters and/or characteristic curves stored in a memory unit, the flow profile reigning in each subsection is determined from the flow velocity of the fluid according to an applied mathematical model.

28. The method as claimed in claim 26, wherein:
for determining the flow, to the extent possible, that subsection is selected, in which the reigning flow profile lies outside a transitional region between laminar and turbulent flow.

29. The method as claimed in claim 26, wherein:
for determining the flow, the flow velocities for the different subsections are provided with weighting factors suitable for their respective flow profiles and then an averaging is made therewith over the flow velocities of the different subsections.

30. The method as claimed in claim 26, wherein:
in the case of small flow rates, that measuring electrode pair is used, which is arranged in the subsection with the smallest cross section.

31. The method as claimed in claim 26, wherein:
in the case of high flow rates, that measuring electrode pair is used, which is arranged in the subsection with the greatest cross section.

32. The method as claimed in claim 26, wherein:
for fluids with a composition, in the case of which the signal noise in the flow range relevant for measuring increases with increasing flow velocity more strongly than the measurement signal, especially in the case of fluids with a small electrical conductivity, there is used, for determining the flow, that measuring electrode pair, which is arranged in the subsection with the greatest cross section.
